(19) United States
(12) Patent Application Publication
(10) Pub. No.: US 2014/0122910 A1
(43) Pub. Date: May 1, 2014

(54) RACK SERVER SYSTEM AND OPERATION METHOD THEREOF

(71) Applicants: INVENTEC (PUDONG) TECHNOLOGY CORPORATION, Shanghai (CN); INVENTEC CORPORATION, Taipei City (TW)

(72) Inventors: Kuo-Shu Chiu, Taipei City (TW); Chien-Chou Chen, Taipei City (TW); Jo-Yu Chang, Taipei City (TW); Yu-Hui Wang, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 13/801,900

(22) Filed: Mar. 13, 2013

(30) Foreign Application Priority Data
Oct. 25, 2012 (CN) 201210413210.4

(51) Int. Cl. G06F 1/32

(52) U.S. Cl. CPC G06F 1/3296
USPC 713/323

(57) ABSTRACT

An operation method of a rack server system includes receiving power information for each of a plurality of nodes, calculating a maximum power consumption value of the rack server system and a total power consumption value of the nodes upon the power information, determining whether a ratio value between the maximum power consumption value and the total power consumption value exceeds a predetermined ratio value and adjusting operation statuses of the nodes, for making the rack server system enter a power saving mode when the ratio value does not exceed the predetermined ratio value. Further, a rack server system includes multiple nodes and a rack management controller. The nodes include a power supply, a base board management controller coupled to the power supply and a connection interface coupled to the baseboard management controller. The rack management controller is coupled to the baseboard management controller through the connection interfaces.

This non-provisional application claims priority under 35 U.S.C. §119(a) on Patent Application No(s). 201210413210.4 filed in China, P.R.C. on Oct. 25, 2012, the entire contents of which are hereby incorporated by reference.

### BACKGROUND

1. Technical Field

The disclosure relates to a rack server; in particular, to a rack server system and an operation method thereof.

2. Related Art

Generally speaking, present day servers typically emphasize individual working efficiencies and functionalities. The servers designed under this concept are particular about partitioning and individual operation. That is, each server dynamically adjusts its power consumption according to the conditions and requirements thereof, for balancing between individual power savings and individual performance.

Because of this, each of the servers may only be able to work individually rather than in collaboration, which frequently results in all of the servers in the server system simultaneously working in similar performance conditions, thereby consuming additional power. Thus, it is desired to effectively reduce the power consumption of the server system overall.

### SUMMARY

One embodiment of the disclosure provides an operation method of a rack server system with a plurality of nodes. The operation method begins with receiving power information for each of the nodes, followed by calculating a maximum power consumption value of the rack server system and a total power consumption value of the nodes based on the power information. The operation method then includes determining whether a ratio value between the maximum power consumption value and the total power consumption value exceeds a predetermined ratio value or not, wherein the ratio value is the total power consumption value divided by the maximum power consumption value. Lastly, the operation method includes adjusting operation statuses of the nodes to make the rack server system enter a power saving mode when the determination result shows that the ratio value does not exceed the predetermined ratio value.

Another embodiment of the disclosure provides a rack server system having a plurality of nodes and a rack management controller. Each of the plurality of nodes comprises a power supply, a baseboard management controller, and a connection interface. The power supply is configured to determine whether to provide a voltage signal or not according to a control signal. The baseboard management controller, coupled to the power supply, is configured to detect an operation status of the node, to provide the power information of the node, and provide the control signal according to an adjustment signal. The connection interface, coupled to the baseboard management controller, is configured to transmit the power information and the adjustment signal. The rack management controller, coupled to the baseboard management controller through the connection interfaces, is configured to receive the power information and to calculate a maximum power consumption value of the rack server system and a total power consumption value of the nodes according to the power information. The rack management controller then is configured to determine whether a ratio value between the maximum power consumption value and the total power consumption value exceeds a predetermined ratio value or not. When the rack management controller determines that the ratio value does not exceed the predetermined ratio value, the rack management controller provides the adjustment signals for adjusting operation statuses of the nodes, so as to makes the rack server system enter a power saving mode, wherein the ratio value is the total power consumption value divided by the maximum power consumption value.

### BRIEF DESCRIPTION OF THE DRAWINGS

The disclosure will become more fully understood from the detailed description given herein below for illustration only, and thus are not limitative of the disclosure, and wherein:

FIG. 1 is a perspective view of a rack server system according to the disclosure;

FIG. 2A is a block diagram of a rack server system according to the disclosure;

FIG. 2B is another block diagram of a rack server system according to the disclosure;

FIG. 3 is a flow chart of an operation method of a rack server system according to the disclosure;

FIG. 4 is a flow chart of another operation method of a rack server system according to the disclosure; and

FIG. 5 is a flow chart of still another operation method of a rack server system according to the disclosure.

### DETAILED DESCRIPTION

The detailed features and advantages of the disclosure are described below in great detail through the following embodiments, and the content of the detailed description is sufficient for those skilled in the art to understand the technical content of the present disclosure and to implement the disclosure accordingly. Based upon the content of the specification, the claims, and the drawings, those skilled in the art can easily understand the relevant objectives and advantages of the disclosure.

The embodiments described below use the same symbol for representing the same or similar components.

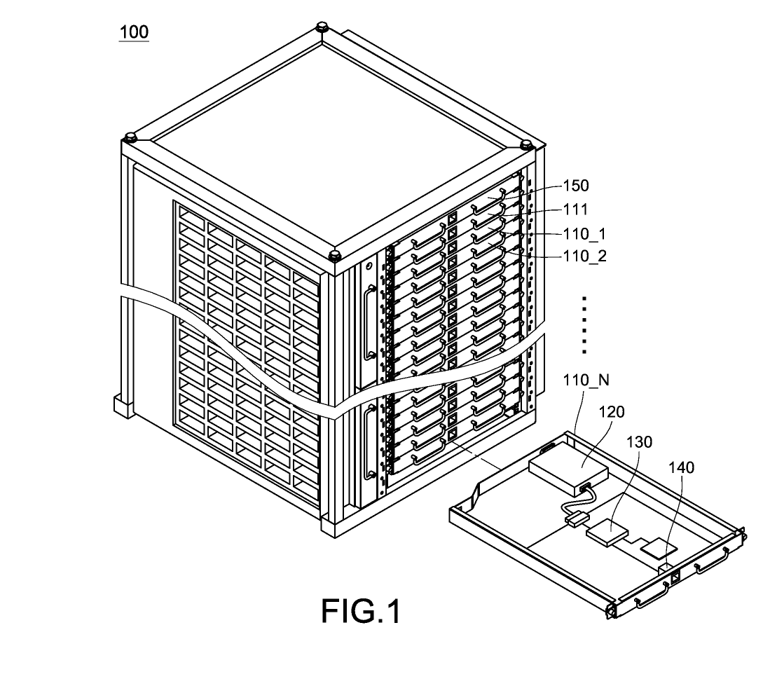

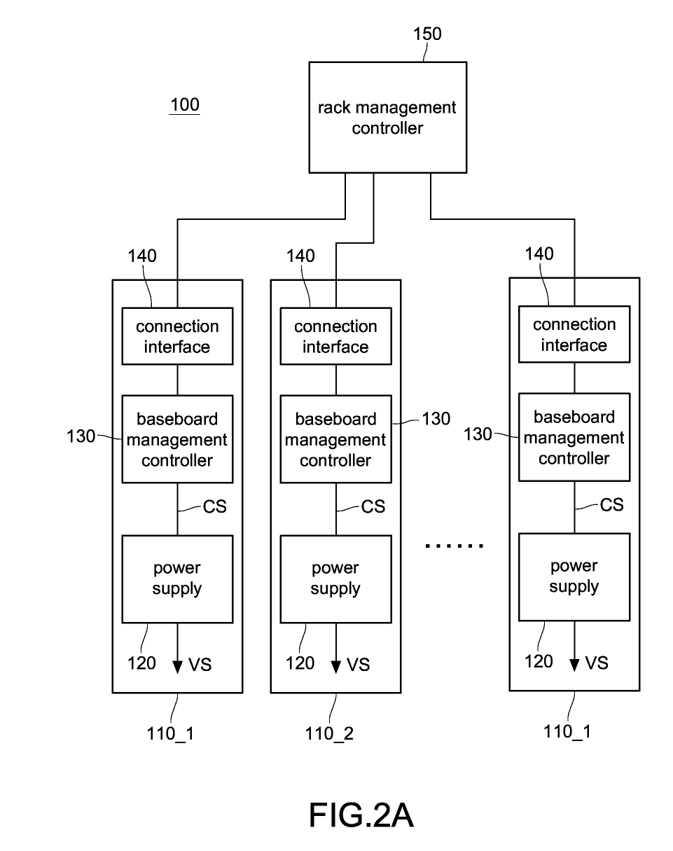

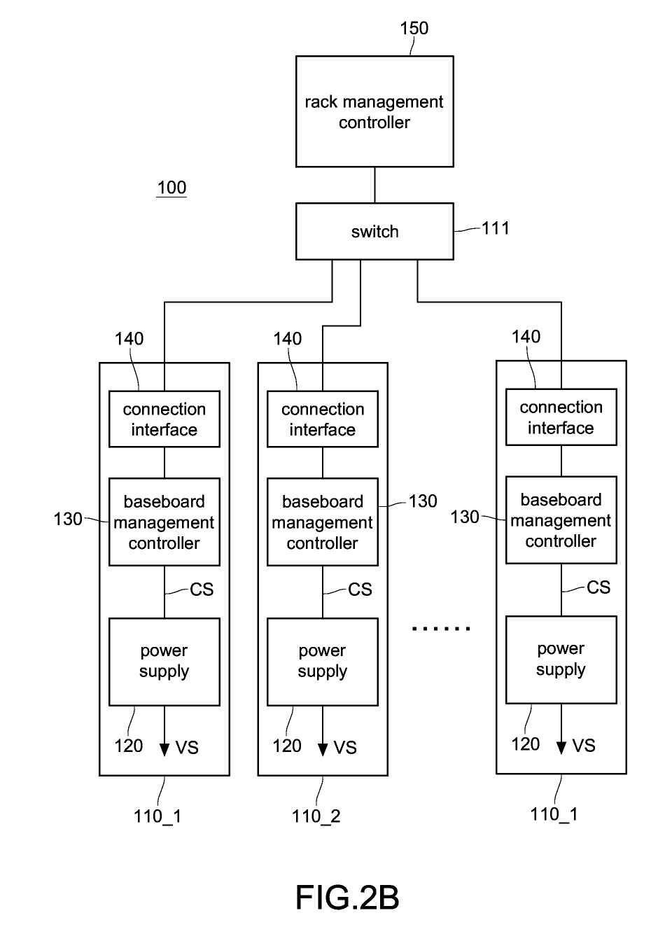

Please refer to FIGS. 1, 2A, and 2B which are a perspective view, a block diagram, and another block diagram of a rack server system according to the disclosure. The rack server system 100 includes several nodes 110_1 to 110_N, a switch unit 111, and a rack management controller (RMC) 150. N is a positive integer greater than 1. The nodes 110_1 to 110_N are coupled to the RMC 150 through the switch unit 111, for executing corresponding data transmission operations. In addition, the rack server system 100 may be a rack data center for providing basis equipments and services IaaS (infrastructure as a service, IaaS), and the switch unit 111 may be a switch hub.

Each of the nodes 110_1 to 110_N comprises a power supply 120, a baseboard management controller (BMC) 130, and a connection interface 140. The power supply 120 is configured to determine whether to provide a voltage signal according to a control signal CS. For example, when the control signal CS is at high logic level, the power supply 120 provides the voltage signal VS for allowing the corresponding nodes to execute operations. When the control signal CS is at low logic level, the power supply 120 does not provide voltage signal VS for making the corresponding nodes do no operations.

The BMC 130 is coupled to the power supply 120 for detecting the operation statuses of the nodes 110_1 to 110_N, so as to provide the sets of power information of the nodes 110_1 to 110_N. The power information includes the voltages, currents, and power consumptions of the nodes 110_1 to 110_N, etc.

In addition, the BMC 130 may provide control signal CS according to the adjustment signal. That is, the BMC 130 may adjust the logic level of the control signal according to the adjustment signal, for further determining whether the power supply 120 is going to provide the voltage signals VS or not. The connection interface 140 is coupled to the BMC 130 for transmitting the power information and the adjustment signal.

In this embodiment, the connection interface 140 may be an inter-integrated circuit (I²C) bus, a serial peripheral interface (SPI) bus, or a general purpose input output (GPIO) bus.

The RMC 150 is coupled to the BMC 130 through the connection interface 140, for receiving power information (such as the voltages, currents, and power consumptions of the nodes 110_1 to 110_N). Therefore, by coupling to the BMC 130, the RMC 150 may provide an adjustment signal according to the power information so as to adjust the operation statuses of the nodes. For example, the RMC 150 may turn off the power to some of the nodes so as to stop the operations of the nodes and make the rack server system 100 enter a power saving mode. Or the RMC 150 may turn on the powers to some of the nodes so as to activate the operations of the nodes, which makes the rack server system 100 enter a load balance mode.

Moreover, the RMC 150 may calculate the maximum power consumption value of the rack server system 100 and the total power consumption value of the nodes 110_1 to 110_N according to the power information. The maximum power consumption value of the rack server system 100 may be the maximum power which is provided by the power supply of the rack server system 100. In addition, the RMC 150 may further calculate a ratio value between the maximum power consumption value and the total power consumption value, and the ratio value may be the total power consumption value divided by the maximum power consumption value.

Then, the RMC 150 may determine whether the ratio between the maximum power consumption value and the total power consumption value exceeds a predetermined ratio value (such as 50%) or not. When a determination result shows that the ratio value between the maximum power consumption value and the total power consumption value does not exceed the predetermined ratio value, this indicates that the load of the rack server system 100 is relatively small. Thus, the number of the operating nodes thereof may be reduced. The RMC 150 may generate adjustment signals to the nodes 110_1 to 110_N to adjust the operation statuses of the nodes 110_1 to 110_N, thereby making the rack server system 100 enter the power saving mode.

When the determination result shows that the ratio value between the maximum power consumption value and the total power consumption value exceeds the predetermined ratio value, it indicates that the load of the rack server system 100 is relatively large. Consequently, the number of the operating nodes may be increased. The RMC 150 may generate adjustment signals to the nodes 110_1 to 110_N to adjust the operation statuses of the nodes 110_1 to 110_N, thereby making the rack server system 100 enter the load balance mode.

Furthermore, supposing that the all of the nodes 110_1 to 110_N of the rack server system 100 are operating, when the RMC 150 determines that the ratio value does not exceed the predetermined ratio value, the RMC 150 may generate adjustment signals to the nodes 110_1 to 110_N, which makes the rack server system 100 enter the power saving mode.

The predetermined ratio value may be 50%, which means the performance of all the nodes 110_1 to 110_N is not optimum, thus part of the nodes may be able to be shut down.

Before the rack server system 100 enters the power saving mode, the RMC 150 may determine which portion of the nodes whose operations need to be turned off (such as the nodes 110_2 to 110_5) by accessing a look-up table, and then moving the loads (such as the data needing to be processed) of the nodes whose operations need to be turned off (such as the nodes 110_2 to 110_5) to the rest of the nodes (such as the nodes 110_1, 110_6 to 110_N).

In another embodiment of the disclosure, before the rack server system 100 enters the power saving mode, the RMC 150 may access a look-up table to determine which portion of the nodes whose operations need to be turned off (such as the nodes 110_2 to 110_5). Then, the portion of the nodes whose operations need to be turned off (such as the nodes 110_2 to 110_5) may complete their present loads (operations) thereof. When the RMC 150 receives new loads, the new loads may be distributed to the nodes that are continuously operating (such as the nodes 110_1, 110_6 to 110_N).

Then, the RMC 150 may provide adjustment signals to the nodes 110_2 to 110_5, which makes the BMC 130 control the power supply 120 to stop providing the voltage signals VS. By stopping providing the voltage signals VS, power to the portion of the nodes whose operations need to be turned off (such as the nodes 110_2 to 110_5) is turned off. Turning off the power to the portion of the nodes whose operations need to be turned off makes the rack server system 100 enter the power saving mode. The rest of the nodes 110_1, 110_6 to 110_N continues normal operation. Thus, by shutting down part of the operations of the nodes, the amount of data processing of the rack server system 100 may be aggregated into some nodes to effectively reduce power consumption.

On the other hand, suppose that the rack server system 100 only has nodes 110 3 to 110_N operating, and the RMC 150 may determine that the ratio value exceeds the predetermined ratio value. Then, the RMC 150 may generate the adjustment signals to the nodes 110_1 to 110_N, which makes the rack server system 100 enter the load balance mode.

Before the rack server system 100 enters the load balance mode, the RMC 150 may determine the part of the nodes whose operations need to be turned on (such as the nodes 110_1 and 110_2) by accessing a look-up table. The RMC 150 may provide the adjustment signals to the nodes 110_1 and 110_2. Providing the adjustment signals to the nodes 110_1 and 110_2 makes the BMC 130 control the power supply 120 so as to provide the voltage signals VS, which turns on the power to the part of the nodes 110_1 and 110_2. Turning on the power of the part of the nodes 110_1 and 110_2 in turn makes the nodes 110_1 and 110_2 enter the operations of the rack server system 100.

Then the RMC 150 may move the loads of the part of the nodes 110_3 to 110_N to the part of the nodes 110_1 and 110_2 which are added to the operations of the rack server system 100 and this makes the rack server system 100 enter the load balance mode. The object of moving the loads of the part of the nodes 110_3 to 110_N to the part of the nodes 110_1 and 110_2 is to avoid the excessive power consumptions caused by overloads of some nodes.

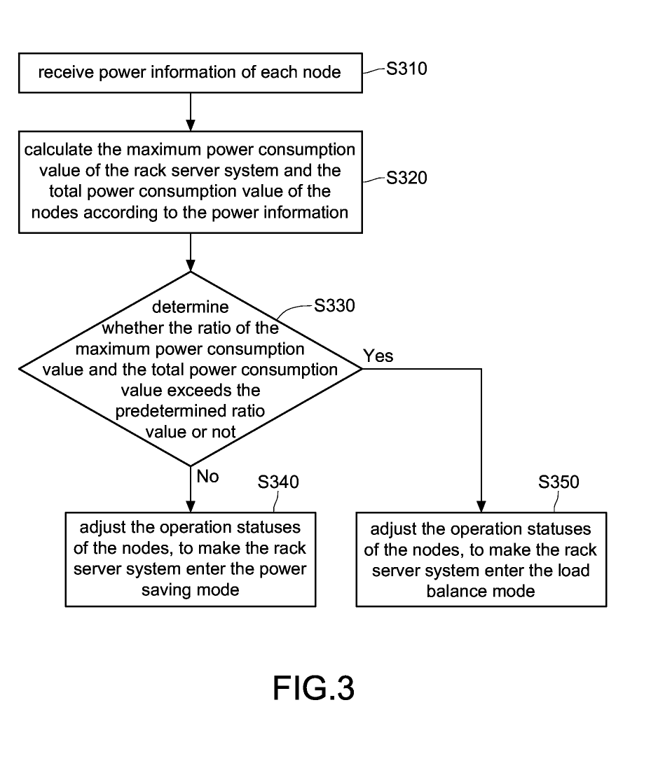

On the basis of the above explanations of the embodiments, and operation method of a rack server system may be induced. Please refer to FIG. 3 which shows a flow chart of the operation method of a rack server system according to the disclosure. The operation method of the rack server system according to the disclosure is applied to a rack server system with several nodes.

The step S310 includes receiving the power information of each node. The step S320 includes calculating the maximum power consumption value of the rack server system and the total power consumption value of the nodes according to the power information. The step S330 includes determining whether the ratio value between the maximum power consumption value and the total power consumption value exceeds the predetermined ratio value or not. The ratio value is the total power consumption value divided by the maximum power consumption value. When the determination result shows that the ratio value does not exceed the predetermined ratio value, the method then proceeds to step S340 which includes adjusting the operation statuses of the nodes for making the rack server system enter the power saving mode. When the determination result shows that the ratio value exceeds the predetermined ratio value, then the method may adjust the operation statuses of the nodes for making the rack server system enter the load balance mode.

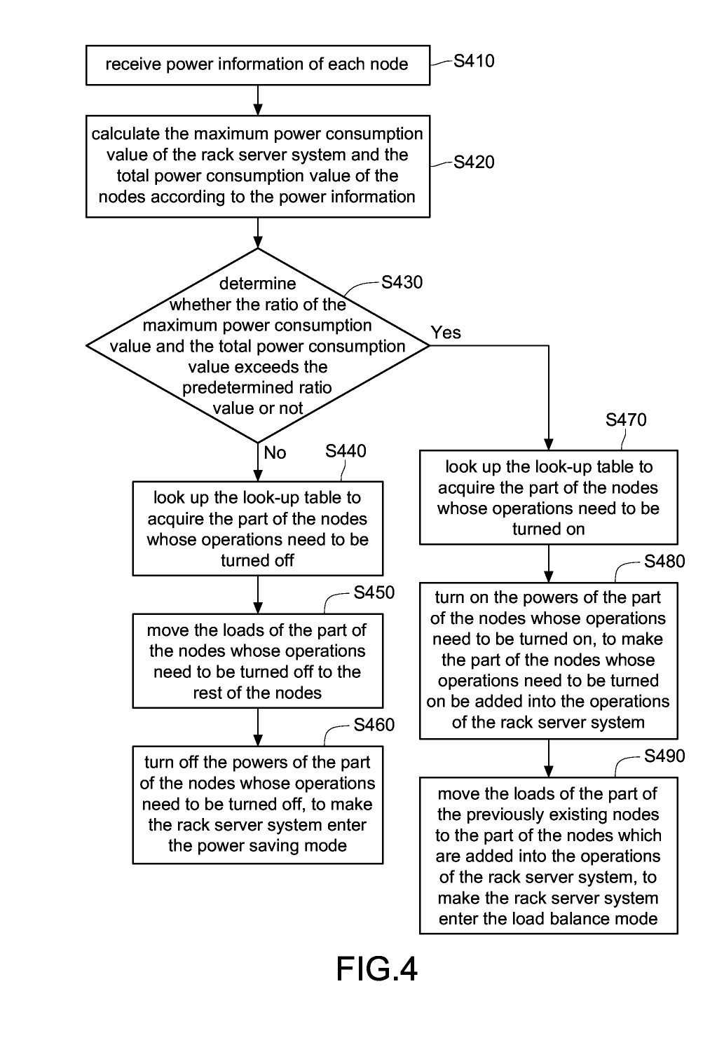

Please refer to FIG. 4 which is a flow chart of another operation method of a rack server system according to the disclosure. The step S410 includes receiving the power information of each node. The step S420 includes calculating the maximum power consumption value of the rack server system and the total power consumption value of the nodes according to the power information.

The step S430 includes determining whether the ratio value between the maximum power consumption value and the total power consumption value exceeds the predetermined ratio value or not. The ratio value is the total power consumption value divided by the maximum power consumption value. When the determination result shows that the ratio value does not exceed the predetermined ratio value, the method then goes to the step S440 including accessing a look-up table to determine the part of the nodes whose operations need to be turned off. Then, the step S450 includes moving the loads of the part of the nodes whose operations need to be turned off to the rest of the nodes. The step S460 includes turning off the power to the part of the nodes whose operations need to be turned off for making the rack server system enter the power saving mode.

In this embodiment, after the step S430, when the determination result shows that the ratio value exceeds the predetermined ratio value, the method then goes to the step S470 including accessing a look-up table to determine the part of the nodes whose operations need to be turned on. Then, the step S480 includes turning on the power to the part of the nodes whose operations need to be turned on for making the part of the nodes whose operations need to be turned on be added into the operations of the rack server system.

Then the step S490 includes moving the loads of the part of the nodes to the part of the nodes which are added into the operations of the rack server system, for making the rack server system enter the load balance mode.

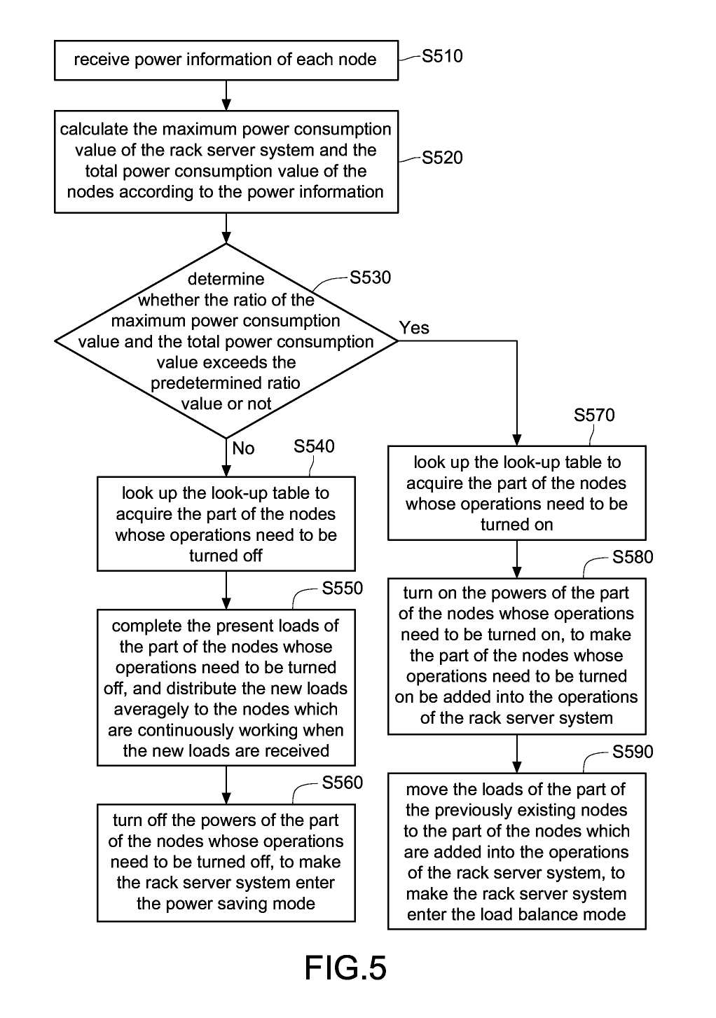

Please refer to FIG. 5 which shows a flow chart of still another operation method of a rack server system according to the disclosure. The step S510 includes receiving the power information of each node. The step S520 includes calculating the maximum power consumption value of the rack server system and the total power consumption value of the nodes according to the power information.

The step S530 includes determining whether the ratio value between the maximum power consumption value and the total power consumption value exceeds the predetermined ratio value or not. The ratio value is the total power consumption value divided by the maximum power consumption value. When the determination result shows that the ratio value does not exceed the predetermined ratio value, the method then proceeds to the step S540 including accessing a look-up table to determine the part of the nodes whose operations need to be turned off. Then, the step S550 includes that the part of the nodes whose operations need to be turned off complete the present loads thereof, and distribute new loads to the nodes which are continuously working when the new loads are received. The step S560 includes turning off the power of the part of the nodes whose operations need to be turned off for making the rack server system enter the power saving mode.

In this embodiment, after the step S530, when the determination result shows that the ratio value exceeds the predetermined ratio value, the method then goes to the step S570 including accessing a look-up table to determine the part of the nodes whose operations need to be turned on. Then, the step S580 includes turning on the power to the part of the nodes whose operations need to be turned on for making the part of the nodes whose operations need to be turned on be added into the operations of the rack server system. Then the step S590 includes moving the loads of the part of the nodes to the part of the nodes which are added into the operations of the rack server system, for making the rack server system enter the load balance mode.

The rack server system and the operation method thereof according to the embodiments of the disclosure receive the power information of each node through the RMC, and adjust the operations of each of the nodes according to the power information, which makes the rack server system enter the power saving mode or the load balance mode, in order to effectively reduce the power consumptions.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the disclosure pertains without departing from its spirit and scope.

Accordingly, the scope of the disclosure is defined by the appended claims rather than the foregoing description and the exemplary embodiments described therein.

What is claimed is:

1. An operation method of a rack server system including a plurality of nodes, the operation method comprising:
receiving power information for each of the plurality of nodes;
calculating a maximum power consumption value of the rack server system and a total power consumption value of the plurality of nodes according to the power information;
determining whether a ratio value between the maximum power consumption value and the total power consumption value exceeds a predetermined ratio value or not; and
adjusting operation statuses of the plurality of nodes to make the rack server system enter a power saving mode when a determination result shows that the ratio value does not exceed the predetermined ratio value,.

2. The operation method of the rack server system according to claim 1, wherein the step of determining whether the ratio value exceeds the predetermined ratio value or not further includes:
when the determination result shows that the ratio value exceeds the predetermined ratio value, adjusting the operation statuses of the plurality of nodes to make the rack server system enter a load balance mode.

3. The operation method of the rack server system according to claim 2, wherein the step of making the rack server system enter the load balance mode includes:
accessing a look-up table to determine a part of the plurality of nodes whose operations need to be turned on;
turning on power to the part of the plurality of nodes whose operations need to be turned on such that the part of the plurality of nodes whose operations need to be turned on is added into the operations of the rack server system; and
moving loads on a part of the previously existing nodes to the part of the plurality of nodes which are added into the operations of the rack server system, so as to make the rack server system enter the load balance mode.

4. The operation method of the rack server system according to claim 1, wherein the step of making the rack server mode enter the power saving mode includes:
accessing a look-up table to determine a part of the plurality of nodes whose operations need to be turned off;
moving loads of the part of the plurality of nodes whose operations need to be turned off to the rest of the plurality of nodes; and
turning off power of the part of the plurality of nodes whose operations need to be turned off so as to make the rack server system enter the power saving mode.

5. The operation method of the rack server system according to claim 1, wherein the step of making the rack server system enter the power saving mode includes:
accessing a look-up table to determine a part of the plurality of nodes whose operations need to be turned off;
completing the present loads by the part of the plurality of nodes whose operations need to be turned off, and distributing new loads to the plurality of nodes which are continuously working when receiving the new loads; and
turning off power to the part of the plurality of nodes whose operations need to be turned off, so as to make the rack server system enter the power saving mode.

6. The operation method of the rack server system according to claim 1, wherein the ratio value is the total power consumption value divided by the maximum power consumption value

7. A rack server system, comprising:
a plurality of nodes, each of the plurality of nodes comprising:
a power supply for determining whether to provide a voltage signal or not according to a control signal;
a baseboard management controller coupled to the power supply, for detecting an operation status of a node, to provide a power information of the node and provide the control signal according to an adjustment signal; and
a connection interface coupled to the baseboard management controller, for transmitting the power information and the adjustment signal; and
a rack management controller coupled to the baseboard management controller through the connection interfaces, configured to receive the power information and calculating a maximum power consumption value of the rack server system and a total power consumption value of the nodes according to the power information, and configured to determine whether a ratio value between the maximum power consumption value and the total power consumption value exceeds a predetermined ratio value or not, wherein when the rack management controller determines that the ratio value does not exceed the predetermined ratio value, the rack management controller provides the adjustment signals for adjusting operation statuses of the plurality of nodes, so as to make the rack server system enter a power saving mode, and wherein the ratio value is the total power consumption value divided by the maximum power consumption value.

8. The rack server system according to claim 7, wherein the rack management controller is configured to generate the adjustment signals to make the rack server system enter a load balance mode when the rack management controller determines that the ratio value exceeds the predetermined ratio value.

9. The rack server system according to claim 8, wherein the rack management controller is further configured to access a look-up table to determine a part of the plurality of nodes whose operations need to be turned on, and to provide the adjustment signals for turning on power to the part of the plurality of nodes whose operations need to be turned on so as to make the part of the plurality of nodes whose operations need to be turned on be added into operations of the rack server system, and to move loads of part of the previously existing nodes to the part of the plurality of nodes which are added into the operations of the rack server system so as to make the rack server system enter the load balance mode.

10. The rack server system according to claim 7, wherein the rack management controller is further configured to access a look-up table to determine part of the plurality of nodes whose operations need to be turned off, and to move loads of the part of the plurality of nodes whose operations need to be turned off to the rest of the plurality of nodes, and to provide the adjustment signals for turning off power to the part of the plurality of nodes whose operations need to be turned off so as to make the rack server system enter the power saving mode.

11. The rack server system according to claim 7, wherein the rack management controller is further configured to access a look-up table to determine a part of the plurality of nodes whose operations need to be turned off, and the part of the plurality of nodes whose operations need to be turned off completes the present loads thereof, and when the rack management controller receives new loads, the new loads are averagely distributed to the nodes which are continuously working, then the rack management controller provides the adjustment signals for turning off power to the part of the plurality of nodes whose operations need to be turned off, to make the rack server system enter the power saving mode.
